(19) United States
(12) Patent Application Publication
(10) Pub. No.: US 2019/0321847 A1
(43) Pub. Date: Oct. 24, 2019

(54) SPRAY NOZZLE

(71) Applicant: TOSHIBA MITSUBISHI-ELECTRIC INDUSTRIAL SYSTEMS CORPORATION, Chuo-ku (JP)

(72) Inventor: Yasushi MORIZONO, Tokyo (JP)

(73) Assignee: TOSHIBA MITSUBISHI-ELECTRIC INDUSTRIAL SYSTEMS CORPORATION, Chuo-ku (JP)

(21) Appl. No.: 16/339,795

(22) PCT Filed: Jul. 27, 2017
(86) PCT No.: PCT/JP2017/027332

§ 371 Date: Apr. 5, 2019

(30) Foreign Application Priority Data
Nov. 30, 2016 (JP) 2016-232976

(51) Int. Cl. B05B 14/42

(52) U.S. Cl. CPC B05B 14/42; F24F 6/14

(57) ABSTRACT

A spray nozzle configured to atomize and spray liquid by gas. The spray nozzle includes a liquid dripping prevention mechanism configured to prevent dripping of the liquid from the spray nozzle caused as a result of electrically charged fine particles of the liquid sprayed from the spray nozzle being attracted to and adhering to the spray nozzle.

### FIELD

The present disclosure relates to a spray nozzle.

### BACKGROUND

For the purpose of humidification, temperature lowering, sterilization or the like, a spray nozzle that atomizes (nebulizes) and sprays liquid by gas has been widely used.

### CITATION LIST

### Patent Literature

[PTL 1] JP 2014-188284 A

### SUMMARY

For example, assume a case where pure water is sprayed in a clean room. Fine particles of pure water sprayed from a spray nozzle are electrically charged during, for example, passing through a nozzle tip portion and, on the other hand, opposite electric charges accumulate at a periphery of the nozzle tip portion. Accordingly, the sprayed fine particles of pure water are attracted to and adhere to the periphery of the nozzle tip portion. As a result of this event continuously occurring, the spray nozzle begins to wet, and this eventually results in dripping of water droplets (liquid pure water) from the spray nozzle, which is sometimes called liquid drip.

An object of the present disclosure is to provide a spray nozzle that prevents dripping of water droplets.

According to an aspect of the present disclosure, there is provided a spray nozzle configured to atomize and spray liquid by gas. The spray nozzle includes a liquid dripping prevention mechanism configured to prevent dripping of the liquid from the spray nozzle caused as a result of electrically charged fine particles of the liquid sprayed from the spray nozzle being attracted and adhering to the spray nozzle.

### BRIEF DESCRIPTION OF DRAWINGS

FIG. 1 is a diagram illustrating an exemplary configuration of a two-fluid spray system that uses a two-fluid nozzle of a first embodiment.

FIG. 2 is a diagram illustrating an exemplary configuration of the two-fluid nozzle of the first embodiment.

FIG. 3 is a diagram illustrating an exemplary configuration of a two-fluid nozzle of a second embodiment.

FIG. 4 is a diagram illustrating an exemplary configuration of a two-fluid nozzle of a third embodiment.

FIG. 5 is a diagram illustrating an exemplary configuration of a two-fluid nozzle of a fourth embodiment.

FIG. 6 is a diagram illustrating an example of an appearance of the two-fluid nozzle of the fourth embodiment.

### DESCRIPTION OF EMBODIMENTS

Hereinafter, embodiments will be explained with reference to the drawings.

### First Embodiment

First, a first embodiment will be explained.

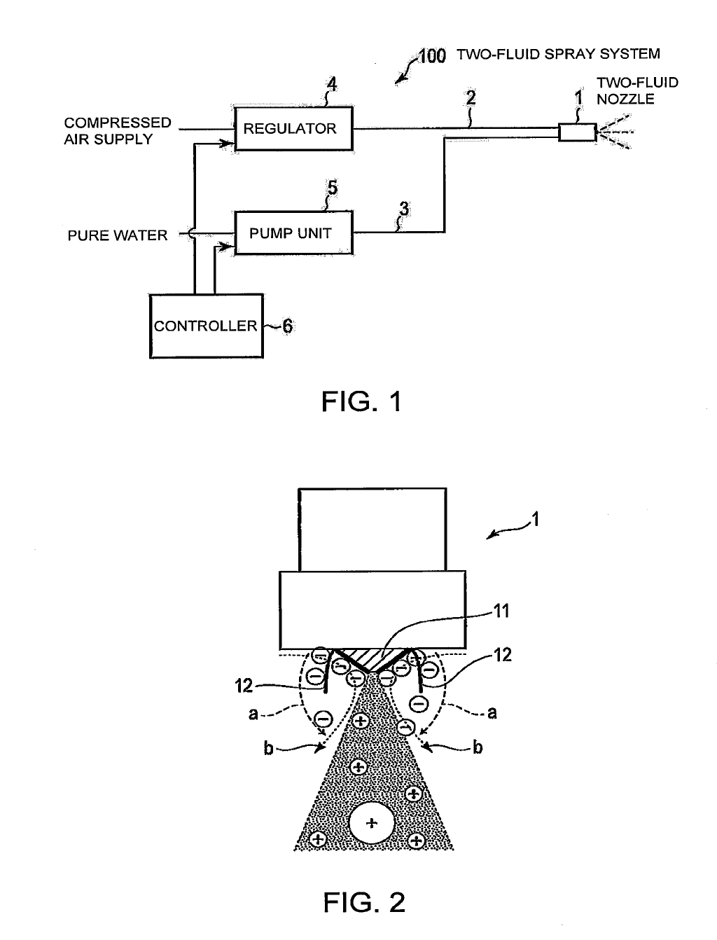

FIG. 1 is a diagram illustrating an exemplary configuration of a two-fluid spray system 100 that uses a two-fluid nozzle (spray nozzle) 1 of the first embodiment.

As shown in FIG. 1, the two-fluid spray system 100 includes the two-fluid nozzle 1, a compressed air supply path 2, a pure water supply path 3, a regulator 4, a pump unit 5, and a controller 6.

The two-fluid nozzle 1 atomizes pure water supplied from a pure water supply port by compressed air supplied from a compressed air supply port and sprays the pure water from a spray port. The compressed air supply path 2 is connected to the compressed air supply port of the two-fluid nozzle 1, and the pure water supply path 3 is connected to the pure water supply port of the two-fluid nozzle 1.

The regulator 4 is a device for supplying compressed air of appropriate amount and appropriate pressure to the two-fluid nozzle 1 via the compressed air supply path 2. Also, the pump unit 5 is a device for supplying pure water of appropriate amount and appropriate pressure to the two-fluid nozzle 1 via the pure water supply path 3. The controller 6 is a device for controlling driving of the regulator 4 and the pump unit 5.

FIG. 2 is a diagram illustrating an exemplary configuration of the two-fluid nozzle 1 of the present embodiment. More specifically, FIG. 2 is a diagram for explaining a liquid dripping prevention mechanism in the two-fluid nozzle 1 of the present embodiment.

In the present embodiment, a self-discharge electrode (a corona discharge inducing part) 12 for inducing a corona discharge (a in FIG. 2) is installed to discharge electric charges accumulating at a nozzle tip portion 11. The self-discharge electrode 12 is, for example, a needle made of metal, and provided in contact with the nozzle tip portion 11. It is preferable that the self-discharge electrode 12 is provided to discharge electric charges accumulating at the nozzle tip portion 11 toward fine particles of pure water sprayed from the spray port, more specifically, to offset the electric charges accumulating at the nozzle tip portion 11 with electric charges of fine particles of pure water sprayed from the spray port.

When the fine particles of pure water sprayed from the spray port are electrically charged (e.g., positively (to plus)) during being sprayed, opposite (e.g., negative (minus)) electric charges accumulate at a periphery of the nozzle tip portion. If this situation is left untreated, the sprayed fine particles of pure water are attracted to and adhere to the periphery of the nozzle tip portion. Dripping of water droplets (liquid pure water) occurs due to this event.

On the other hand, in the two-fluid nozzle 1 of the present embodiment, the self-discharge electrode 12 for inducing a corona discharge is installed to discharge the electric charges accumulating at the nozzle tip portion 11, whereby the cause of the sprayed fine particles of pure water being attracted to the periphery of the nozzle tip portion is eliminated. With this liquid dripping prevention mechanism, the two-fluid nozzle 1 of the present embodiment prevents dripping of water droplets (liquid pure water), which is caused by the event of the sprayed fine particles of pure water being attracted to and adhere to the periphery of the nozzle tip portion.

Note that slight wetting may occur at the nozzle tip portion 11 due to adhesion of some of fine particles of pure water to be sprayed, not the attracted fine particles of pure water. This wetting is carried by airflow (b in FIG. 2) occurring around the spray port and sprayed along with fine particles of pure water sprayed from the spray port, and thus does not result in dripping of water droplets (liquid pure water).

In this way, according to the present embodiment, dripping of water droplets may be prevented.

### Second Embodiment

Then, a second embodiment will be explained. The two-fluid nozzle 1 of the present embodiment is also applied to a two-fluid spray system similar to that of the first embodiment. Accordingly, explanations of an exemplary configuration of the two-fluid spray system will be omitted. Further, in explanations of the present embodiment, the same reference numeral (1) as that in the explanations of the first embodiment will be used for the two-fluid nozzle.

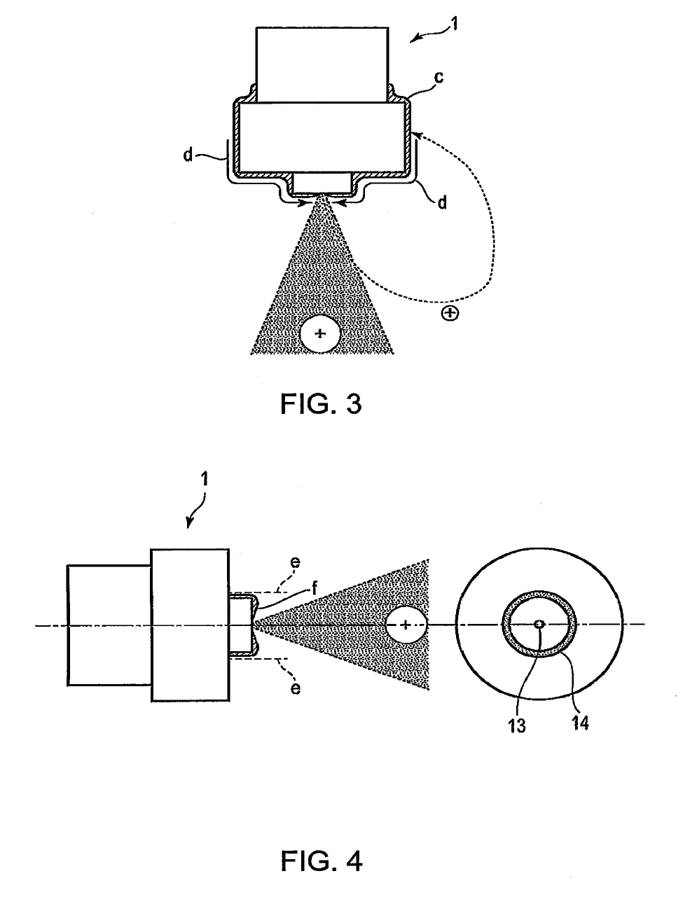

FIG. 3 is a diagram illustrating an exemplary configuration of the two-fluid nozzle 1 of the present embodiment. More specifically, FIG. 3 is a diagram for explaining a liquid dripping prevention mechanism in the two-fluid nozzle 1 of the present embodiment.

In the present embodiment, firstly, the spray port of the two-fluid nozzle 1 is disposed to face vertically downward. And secondly, a spray surface on which the spray port is provided is formed to have a shape that causes liquid (c in FIG. 3) adhering to peripheral walls of the two-fluid nozzle 1 including the spray surface to be led to the spray port by gravity (d in FIG. 3).

Assume that fine particles of pure water sprayed from the spray port are electrically charged while opposite electric charges accumulate at the periphery of the spray port, and thus the sprayed fine particles of pure water are attracted to the periphery of the spray port and wetting spreads.

With the spray port being disposed to face vertically downward and with the spray surface including the spray port being formed so as to cause the liquid adhering to the peripheral walls of the two-fluid nozzle 1 to be led to the spray port by gravity, the two-fluid nozzle 1 of the present embodiment leads the spread wetting to the spray port, carries it by airflow occurring around the spray port and thereby sprays it along with the fine particles of pure water sprayed from the spray port. With this liquid dripping prevention mechanism, the two-fluid nozzle 1 of the present embodiment prevents dripping of water droplets (liquid pure water), which is caused by the event of the sprayed fine particles of pure water being attracted to and adhering to the periphery of the nozzle tip portion.

In this way, according to the present embodiment, dripping of water droplets may be prevented.

### Third Embodiment

Then, a third embodiment will be explained. The two-fluid nozzle 1 of the present embodiment is also applied to a two-fluid spray system similar to those of the first and the second embodiments. Accordingly, explanations of an exemplary configuration of the two-fluid spray system will be omitted. Further, in explanations of the present embodiment, the same reference numeral (1) as that in the explanations of the first embodiment will be used for the two-fluid nozzle.

FIG. 4 is a diagram illustrating an exemplary configuration of the two-fluid nozzle 1 of the present embodiment. More specifically, FIG. 4 is a diagram for explaining a liquid dripping prevention mechanism in the two-fluid nozzle 1 of the present embodiment.

In the present embodiment, a gas exhaust port 14 is provided on a spray surface including a spray port 13 of the two-fluid nozzle 1 so as to surround the spray port 13. Further, in the present embodiment, compressed air supplied to the two-fluid nozzle 1 via the compressed air supply path 2 is used for ejection of air from the gas exhaust port 14, besides for atomization of pure water supplied to the two-fluid nozzle 1 via the pure water supply path 3.

Assume that fine particles of pure water sprayed from the spray port are electrically charged while opposite electric charges accumulate at the periphery of the spray port, and thus the sprayed fine particles of pure water are attracted to the periphery of the spray port and wetting has begun.

With the gas exhaust port 14 being provided so as to surround the spray port 13, the two-fluid nozzle 1 of the present embodiment limits the spread of the wetting (f in FIG. 4) to a position (e in FIG. 4) where air is ejected from the gas exhaust port 14. The wetting that has reached the gas exhaust port 14 is ejected along with the air ejected from the gas exhaust port 14, and thus does not result in dripping of water droplets (liquid pure water). With this liquid dripping prevention mechanism, the two-fluid nozzle 1 of the present embodiment prevents dripping of water droplets (liquid pure water), which is caused by the event of the sprayed fine particles of pure water being attracted to and adhering to the periphery of the nozzle tip portion.

In this way, according to the present embodiment, dripping of water droplets may be prevented.

### Fourth Embodiment

Then, a fourth embodiment will be explained. The two-fluid nozzle 1 of the present embodiment is also applied to a two-fluid spray system similar to those of the first to the third embodiments. Accordingly, explanations of an exemplary configuration of the two-fluid spray system will be omitted. Further, in explanations of the present embodiment, the same reference numeral (1) as that in the explanations of the first embodiment will be used for the two-fluid nozzle.

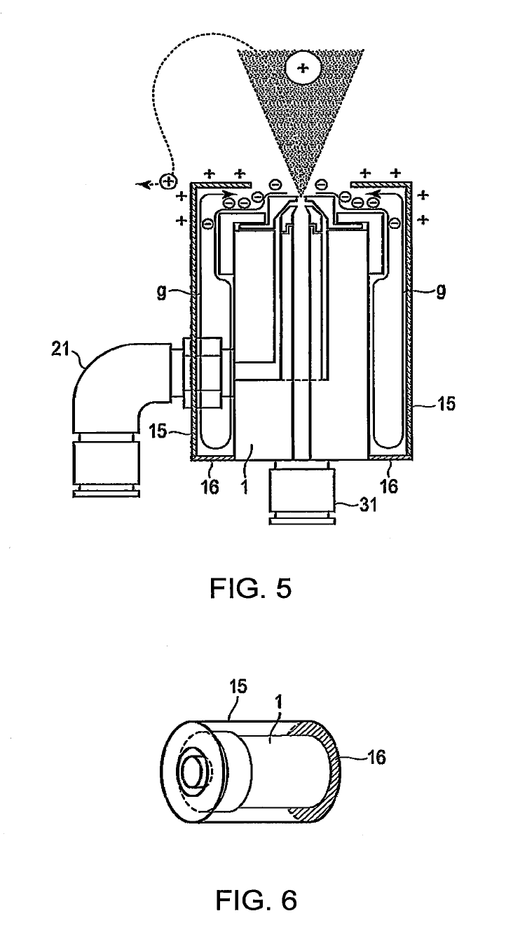

FIG. 5 is a diagram illustrating an exemplary configuration of the two-fluid nozzle 1 of the present embodiment. More specifically, FIG. 5 is a diagram for explaining a liquid dripping prevention mechanism in the two-fluid nozzle 1 of the present embodiment.

In the present embodiment, a shield part 15 made of a material having electrostatic chargeability is provided so as to cover a portion of the two-fluid nozzle 1 where wetting is undesired, in other words, a portion where it is wanted to prevent the sprayed fine particles of pure water from being attracted and adhering. Further, the shield part 15 is provided in a state where a sufficient creepage distance (g in FIG. 5) from the nozzle tip portion, where electric charges opposite to the electrically charged fine particles of pure water accumulate, is secured to avoid decrease in a surface potential due to creeping discharge from the nozzle tip portion. Note that reference numeral 16 in FIG. 5 denotes a fixing part for fixing the shield part 15 such that the shield part 15 covers the circumference of the two-fluid nozzle 1.

With a sufficient creepage distance from the nozzle tip portion being secured, the surface of the shield part 15 can maintain its charged state in the same polarity (e.g., positive (plus)) as the electrically charged fine particles of pure water. Thus, the surface of the shield part 15 does not attract the electrically charged fine particles of pure water. With this liquid dripping prevention mechanism, the two-fluid nozzle 1 of the present embodiment prevents dripping of water droplets (liquid pure water), which is caused by the event of the sprayed fine particles of pure water being attracted to and adhering to the periphery of the nozzle tip portion.

FIG. 6 is a diagram illustrating an example of an appearance of the two-fluid nozzle 1 (liquid dripping prevention mechanism) of the present embodiment. Adhesion of the sprayed fine particles of pure water to the two-fluid nozzle 1 may be prevented by disposing the shield part 15 made of a material having electrostatic chargeability so as to cover the circumference of the two-fluid nozzle 1, which includes the periphery of the nozzle tip portion, in a state where a sufficient creepage distance is secured to avoid decrease in a surface potential due to creeping discharge from the nozzle tip portion, as shown in FIG. 6.

Note that the shield part 15 is not necessarily provided so as to surround the entire circumference of the two-fluid nozzle 1. For example, even when a part of side surfaces of the two-fluid nozzle 1 is exposed, adhesion of the sprayed fine particles of pure water to the two-fluid nozzle 1 may be prevented by disposing the shield part 15 so as to cover at least the periphery of the nozzle tip portion in a state where a sufficient creepage distance is secured to avoid decrease in a surface potential due to creeping discharge from the nozzle tip portion.

In this way, according to the present embodiment, dripping of water droplets may be prevented.

In the foregoing explanations, the two-fluid nozzle that atomizes (nebulizes) and sprays liquid by gas has been given as an example; however, the measures explained in each embodiment are applicable not only to the two-fluid nozzle but also to, for example, a single-fluid nozzle that is only supplied with pressurized liquid and atomizes (nebulizes) the liquid by the pressure of the liquid and sprays it. In the case of the two-fluid nozzle, both water and air pressures are typically within about 500 kPa, while in the case of the single-fluid nozzle, water pressure is typically about 5 MPa. By pressuring liquid to a higher pressure than the two-fluid nozzle, the single-fluid nozzle can atomize (nebulize) the liquid with the liquid alone and spray it.

Further, the present disclosure is not strictly limited to the above embodiments; in practical applications, the present disclosure may be embodied with various modifications to the constituent elements without departing from the scope of the present disclosure. Moreover, multiple constituent elements disclosed in the above embodiments may be combined as appropriate to form various disclosures. For example, some constituent elements among all constituent elements shown in the embodiments may be removed. Also, the constituent elements in different embodiments may be combined as appropriate.

1. A spray nozzle configured to atomize and spray liquid by gas, comprising:
a liquid dripping prevention mechanism configured to prevent dripping of the liquid from the spray nozzle caused as a result of electrically charged fine particles of the liquid sprayed from the spray nozzle being attracted to and adhering to the spray nozzle,
wherein the liquid dripping prevention mechanism is provided in contact with a nozzle tip portion, and includes a self-discharge electrode made of a metal material for inducing a corona discharge to discharge electric charges accumulating at the nozzle tip portion.

2. (canceled)

3. The spray nozzle according to claim 1, wherein the self-discharge electrode is provided to discharge the electric charges accumulating at the nozzle tip portion toward fine particles of the liquid sprayed from the spray nozzle.

4-6. (canceled)

7. A spray nozzle configured to atomize pressurized liquid by pressure of the liquid and spray the liquid, comprising:
a liquid dripping prevention mechanism configured to prevent dripping of the liquid from the spray nozzle caused as a result of electrically charged fine particles of the liquid sprayed from the spray nozzle being attracted to and adhering to the spray nozzle,
wherein the liquid dripping prevention mechanism is provided in contact with a nozzle tip portion, and includes a self-discharge electrode made of a metal material for inducing a corona discharge to discharge electric charges accumulating at the nozzle tip portion.

8. (canceled)

9. The spray nozzle according to claim 7, wherein the self-discharge electrode is provided to discharge the electric charges accumulating at the nozzle tip portion toward fine particles of the liquid sprayed from the spray nozzle.

10-12. (canceled)
